(19) United States
(12) Patent Application Publication
(10) Pub. No.: US 2013/0277035 A1
(43) Pub. Date: Oct. 24, 2013

(54) Manufacturing Method of Carbonaceous Heat Sink

(71) Applicant: SHUOEN TECH. CO., LTD., Miaoli City (TW)

(72) Inventors: Hsu-Tien Hu, Miaoli City (TW); Pi-Min Lin, Miaoli City (TW); Chao-Yin Chuang, Miaoli City (TW)

(73) Assignee: Shuoen Tech. Co., Ltd., Miaoli City (TW)

(21) Appl. No.: 13/865,280

(22) Filed: Apr. 18, 2013

(30) Foreign Application Priority Data
Apr. 20, 2012 (TW) 101114176

(51) Int. Cl. B29C 43/00; F28F 21/02

(52) U.S. Cl. CPC B29C 43/003; F28F 21/02
USPC 165/185; 264/319; 264/29.1

(57) ABSTRACT

A manufacturing method of carbonaceous heat sink includes a mixing step and a molding step. In the mixing step, a graphite material is mixed with a thermosetting binder to obtain a mixture. In the molding step, the mixture is pressure formed with a mold into the carbonaceous heat sink, Preferably, the carbonaceous heat sink can increase its carbonaceous percentage by using a heat treating step. The manufacturing method can produce carbonaceous heat sinks with a high carbonaceous percentage with a low cost.

### BACKGROUND OF THE INVENTION

1. Field of Invention

The present invention relates to a manufacturing method of heat sink, and more particularly a manufacturing method of carbonaceous heat sink.

2. Description of the Related Art

Metal is capable of spreading heat into the surrounding environment to achieve a heat dissipation effect, thus conventional heat sinks are generally made of metal. In addition, metal has a high mechanical strength and processability and can be formed into heat sinks with complicated shapes, for example by electroplating, extruding or machining. However, metal has a high density. If a lightweight heat sink is needed, the heat sink must be fabricated with a multi-fin design by complicated processes, increasing the manufacturing cost. A heat sink can be made by a simple molding process but the weight is difficult to be lowered. Furthermore, the molded heat sink has a smaller heat dissipation area than that of the multi-fin heat sink described above, and thus have a poorer heat dissipation performance. But metal, particularly aluminum, is still the primary choice for manufacturing heat sinks in the industry.

In addition to metal, a carbonaceous material is another option for manufacturing heat sinks. The carbonaceous material is an abundant substance in nature and have advantages like heat conducting, lightweight and inexpensive. Especially, application and technology of a graphite material on heat dissipation have had a great advancement recently. However, there are some machining problems when directly machining a block graphite material into heat sinks with specific geometries. The graphite material has a laminar structure, i.e. the bonding between carbon atoms on the same layer are very strong but the bonding between carbon atoms on different layers are weaker. Thus, peeling or cracking may happen during machining processes, causing the carbonaceous material has a poor machinability. Therefore, the carbonaceous material is difficult to be formed into a shape with specific geometries and has a poor physical strength, resulting in that the carbonaceous material has a high machining cost.

Except the machining processes described above, a heat conducting plastic containing graphite powder for the carbonaceous material has also been developed in the industry. The heat conducting plastic is thermoplastic and can be injection molded into heat sinks. The heat sinks made in this manner are easy to be manufactured and cost effective. However, because injection molding has a high requirement for material flowability, the ratio of the carbonaceous material in the heat conducting plastic is relatively low, causing the thermal conductivity of the heat conducting plastic is not sufficient. Generally, its thermal conductivity coefficient is lower than 10 W/m.k. Thus, the heat sinks made in this manner has a poorer heat dissipation performance and can only be used in low-end heat sinks market.

In summary, there is still a need to make use of the heat conducting property of the carbonaceous material to develop high performance carbonaceous heat sinks by a cost effective molding process.

To overcome the shortcomings, the present invention provides a manufacturing method of carbonaceous heat sink to mitigate or obviate the aforementioned problems.

### SUMMARY OF THE INVENTION

The primary objective of the present invention is to provide a manufacturing method of carbonaceous heat sink. Thus, the heat sink of the present invention with a high graphite percentage can not only have an adequate heat dissipation performance due to the heat conducting property of graphite, but also can be formed by a simple and cost effective molding process.

A manufacturing method of carbonaceous heat sink in accordance with the present invention may comprise a mixing step and a molding step.

In the mixing step, a graphite material is mixed with a thermosetting binder to obtain a mixture, the weight percentage of the graphite material is more than 50% based on the total weight of the mixture, and the graphite material comprises a natural graphite material, an synthetical graphite material or a combination thereof.

In the molding step, the mixture is pressure formed with a mold into the carbonaceous heat sink.

The thermosetting binder may be epoxy, polyimide (PI), phenol formaldehyde (PF), polyurethane (PU) or a combination thereof.

At least one of a metal additive, a ceramic additive and a release agent may be mixed into the mixture in the mixing step, and the molding step may be implemented with a cold pressure forming, a hot pressure forming or an injection molding.

The manufacturing method of a carbonaceous heat sink may comprise a mixing step, a molding step and a heat treating step.

In the mixing step, a graphite material is mixed with a binder to obtain a mixture, and the weight percentage of the graphite material is more than 50% based on the total weight of the mixture.

In the molding step, the mixture is pressure formed with a mold into the carbonaceous heat sink.

In the heat treating step,the formed mixture is heated to a predetermined temperature for a predetermined time and then cooled down, allowing the mixture to be carbonized into a carbonaceous material having a weight percentage of more than 80% based on the total weight of the carbonaceous heat sink and form the carbonaceous heat sink.

The graphite material may comprise a natural graphite material, an synthetical graphite material or a combination thereof, and the binder may comprise a thermoplastic resin and the thermoplastic resin may comprise polycarbonate (PC), polyethylene (PE), polypropylene (PP), polyethylene terephthalate (PET), polyamide (PA) or a combination thereof.

The graphite material may comprise a natural graphite material, an synthetical graphite material or a combination thereof, and the binder may comprise a thermosetting resin and the thermosetting resin may comprise epoxy, polyimide (PI), phenol formaldehyde (PF), polyurethane (PU) or a combination thereof.

At least one of a metal additive, a ceramic additive and a release agent may be mixed into the mixture in the step of mixing, and the molding step may be implemented with a cold pressure forming, a hot pressure forming or an injection molding.

The predetermined temperature may be at least 600° C. so as to allow the mixture to be carbonized and formed, or the predetermined temperature may be at least 2300° C. so as to allow the mixture to be graphitized and formed.

The heat treating step may be performed under a vacuum or an inert gas atmosphere of more than 99% purity.

The graphite material may be a powder, strip, flake, granule graphite material or a combination thereof and the granule graphite material may be made by a granulation process and has a large granule size.

The graphite material may be acid washed with sulfuric acid or hydrofluoric acid and then heat treated at high temperature to remove impurities of the graphite material.

A carbonaceous heat sink in accordance with the present invention may comprise a graphite material and a carbonized binder, wherein the carbonized binder is produced by mixing a polymer resin with the graphite material to obtain a mixture, molding and carbonizing the mixture, and the carbonaceous heat sink comprises a carbonaceous material having a weight percentage of more than 80% based on the total weight of the carbonaceous heat sink.

The polymer resin may be a thermoplastic resin or a thermosetting resin, and the molding may be a cold pressure forming, a hot pressure forming or an injection molding.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart illustrating an embodiment of a manufacturing method of carbonaceous heat sink in accordance with the present invention;

FIG. 2 is a representive diagram of a heat sink made by the manufacturing method of carbonaceous heat sink in accordance with the present invention and applied on a projecting-type LED lamp; and

FIG. 3 is a representive diagram of a heat sink made by the manufacturing method of carbonaceous heat sink in accordance with the present invention and applied on a bulb-type LED lamp.

### DETAILED DESCRIPTION OF THE INVENTION

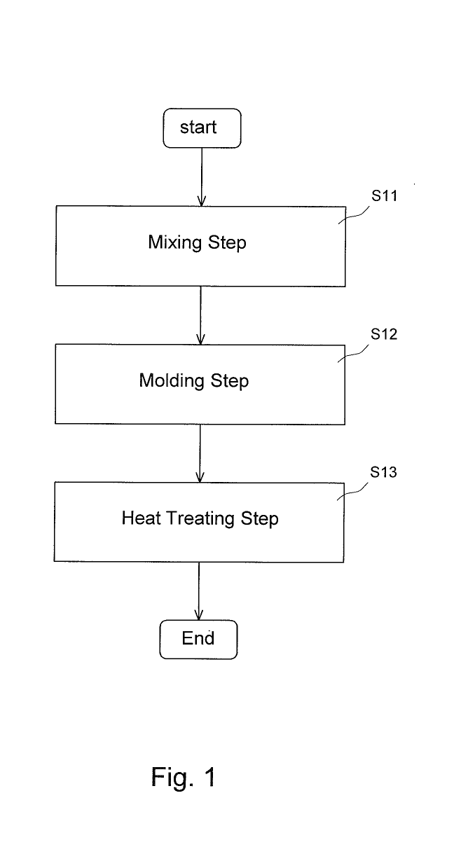

With reference to FIG. 1, a manufacturing method of carbonaceous heat sink in accordance with the present invention comprises a mixing step (S11) and a molding step (S12).

In mixing step (S11), a graphite material is mixed with a fluent binder to obtain a dough-like or paste-like mixture. The weight percentage of the graphite material is more than 50% based on the total weight of the mixture. The fluent binder may be a solution-type resin or a melted resin. In molding step (S12), the dough-like or paste-like mixture is pressure formed with a mold into a carbonaceous heat sink.

In an embodiment of the present invention, the graphite material may be a natural graphite material, an synthetical graphite material or a combination thereof. In addition, the graphite material may be a powder, strip, flake, granule graphite material or a combination thereof. The granule graphite material may be made by a granulation process and has a large granule size. Impurities of the graphite material may be removed from the graphite material by purification processes such as acid washing, alkaline washing or heat treatment. For example, the graphite material is acid washed with sulfuric acid or hydrofluoric acid and then heat treated at 2600° C. for 60 minutes. Thus impurities of the graphite material are removed and the graphite material is purified.

The binder may be a thermoplastic resin or a thermosetting resin. For example, the thermoplastic resin may be polycarbonate (PC), polyethylene (PE), polypropylene (PP), polyethylene terephthalate (PET), polyamide (PA) or a combination thereof. The thermosetting resin may be epoxy, polyimide (PI), phenol formaldehyde (PF), polyurethane (PU) or a combination thereof.

In an embodiment of the present invention, the molding step (S12) may be implemented with a cold pressure forming, a hot pressure forming or an injection molding. It is understood that when the binder is a thermosetting resin, the thermosetting binder can be crosslinked in the mold by heating the mold. On the other hand, when the binder is a thermoplastic resin, the mixture is cooled down and hardened in the mold and then removed from the mold, or is removed from the mold and then cooled down and hardened.

In an embodiment of the present invention, an additive may be mixed into the mixture in the mixing step (S11) to adjust a physical property of the heat sink. For example, the additive may be at least one of a metal additive, a ceramic additive and a release agent. In an embodiment of the present invention, the metal additive may be aluminum, iron or cooper. The ceramic additive may be kaolinite, silca, alumina, aluminum nitride, boron nitride, titania, aluminosilicate or a combination thereof. The release agent may be zinc stearate, magnesium stearate, white wax powder or a combination thereof.

With reference back to FIG. 1, in an embodiment of the present invention, the manufacturing method of carbonaceous heat sink may further comprise a heat treating step (S13). In the heat treating step (S13), the formed mixture is heated to a predetermined temperature for a predetermined time and then cooled down, so the heat sink is more carbonaceous. It is understood that the heat treating step (S13) may be performed under a vacuum or an inert gas atmosphere of more than 99% purity so as to prevent the graphite material or the binder from oxidizing into carbon dioxide. The inert gas may be any one of helium, neon, argon, krypton, xenon, radon or nitrogen.

For example, the predetermined temperature may be more than 600° C. so as to allow the binder in the mixture to be carbonized. Preferably, the predetermined temperature may be more than 2300° C. so as to allow the binder in the mixture to be graphitized. Carbonized or graphitized components are capable of conducting heat more rapidly so the heat sink of the present invention has a better heat dissipation performance. The heat-treated heat sink may contain a carbonaceous material with a weight percentage of more than 80% based on the total weight of the heat sink. In an embodiment of the present invention, the heat treated heat sink may have a porous structure to increase heat dissipation area, improving the heat dissipation performance.

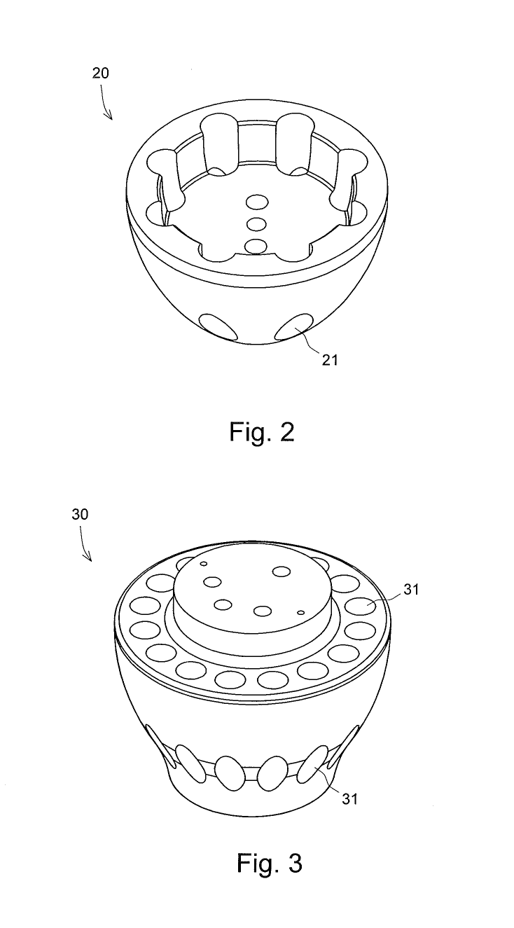

In according to the manufacturing method of the present invention, a heat sink with a complicated shape may be produced by a molding process with various mold designs. For example, as shown in FIGS. 2 and 3, the heat sinks (20, 30) can be applied on spot light or bulb-type LED lamps. In order to increase the heat dissipation performance, multiple through holes (21, 31) may be formed in the heat sinks (20, 30). Alternatively, multiple fins (not shown) can be formed on an outer surface of the heat sinks.

In summary, in the manufacturing method of carbonaceous heat sink in accordance with the present invention, a graphite material is mixed with a binder to obtain a mixture with the graphite material having a weight percentage of more than 50%, and then the mixture is pressure formed with a mold into a carbonaceous heat sink. Thus, the heat sink with a high graphite percentage can not only have an adequate heat dissipation performance due to the heat conducting property of graphite, but also can be formed with a simple and cost effective molding process.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A manufacturing method of a carbonaceous heat sink comprising
a mixing step, wherein
a graphite material is mixed with a thermosetting binder to obtain a mixture,
the weight percentage of the graphite material is more than 50% based on the total weight of the mixture, and
the graphite material comprises a natural graphite material, an synthetical graphite material or a combination thereof, and
a molding step, wherein the mixture is pressure formed with a mold into the carbonaceous heat sink.

2. The manufacturing method of a carbonaceous heat sink as claimed in claim 1, wherein
the thermosetting binder comprises epoxy, polyimide (PI), phenol formaldehyde (PF), polyurethane (PU) or a combination thereof.

3. The manufacturing method of a carbonaceous heat sink as claimed in claim 1, wherein
at least one of a metal additive, a ceramic additive and a release agent is mixed into the mixture in the mixing step, and
the molding step is implemented with a cold pressure forming, a hot pressure forming or an injection molding.

4. A manufacturing method of a carbonaceous heat sink comprising
a mixing step, wherein
a graphite material is mixed with a binder to obtain a mixture, and
the weight percentage of the graphite material is more than 50% based on the total weight of the mixture,
a molding step, wherein the mixture is pressure formed with a mold into the carbonaceous heat sink, and
a heat treating step, wherein the formed mixture is heated to a predetermined temperature for a predetermined time and then cooled down, allowing the mixture to be carbonized into a carbonaceous material having a weight percentage of more than 80% based on the total weight of the carbonaceous heat sink and form the carbonaceous heat sink.

5. The manufacturing method of a carbonaceous heat sink as claimed in claim 4, wherein
the graphite material comprises a natural graphite material, an synthetical graphite material or a combination thereof, and
the binder comprises a thermoplastic resin and the thermoplastic resin comprises polycarbonate (PC), polyethylene (PE), polypropylene (PP), polyethylene terephthalate (PET), polyamide (PA) or a combination thereof.

6. The manufacturing method of a carbonaceous heat sink as claimed in claim 4, wherein
the graphite material comprises a natural graphite material, an synthetical graphite material or a combination thereof, and
the binder comprises a thermosetting resin and the thermosetting resin comprises epoxy, polyimide (PI), phenol formaldehyde (PF), polyurethane (PU) or a combination thereof.

7. The manufacturing method of a carbonaceous heat sink as claimed in claim 4, wherein
at least one of a metal additive, a ceramic additive and a release agent is mixed into the mixture in the step of mixing, and
the molding step is implemented with a cold pressure forming, a hot pressure forming or an injection molding.

8. The manufacturing method of a carbonaceous heat sink as claimed in claim 7, wherein
the predetermined temperature is at least 600° C. so as to allow the mixture to be carbonized,
the step of heat treating is performed under a vacuum or an inert gas atmosphere of more than 99% purity,
the graphite material is a powder, strip, flake, granule graphite material or a combination thereof and the granule graphite material is made by a granulation process and has a large granule size, and
the graphite material is acid washed with sulfuric acid or hydrofluoric acid and then heat treated at high temperature to remove impurities of the graphite material.

9. The manufacturing method of a carbonaceous heat sink as claimed in claim 7, wherein
the predetermined temperature is at least 2300° C. so as to allow the mixture to be graphitized,
the step of heat treating is performed under a vacuum or an inert gas atmosphere of more than 99% purity,
the graphite material is a powder, strip, flake, granule graphite material or a combination thereof and the granule graphite material is made by a granulation process and has a large granule size, and
the graphite material is acid washed with sulfuric acid or hydrofluoric acid and then heat treated at high temperature to remove impurities of the graphite material.

10. A carbonaceous heat sink comprising
a graphite material, and
a carbonized binder, wherein
the carbonized binder is produced by mixing a polymer resin with the graphite material to obtain a mixture, molding and carbonizing the mixture, and
the carbonaceous heat sink comprises a carbonaceous material having a weight percentage of more than 80% based on the total weight of the carbonaceous heat sink.

11. The manufacturing method of a carbonaceous heat sink as claimed in claim 2, wherein
at least one of a metal additive, a ceramic additive and a release agent is mixed into the mixture in the mixing step, and
the molding step is implemented with a cold pressure forming, a hot pressure forming or an injection molding.

12. The manufacturing method of a carbonaceous heat sink as claimed in claim 5, wherein
at least one of a metal additive, a ceramic additive and a release agent is mixed into the mixture in the step of mixing, and
the molding step is implemented with a cold pressure forming, a hot pressure forming or an injection molding.

13. The manufacturing method of a carbonaceous heat sink as claimed in claim 12, wherein
the predetermined temperature is at least 600° C. so as to allow the mixture to be carbonized,
the step of heat treating is performed under a vacuum or an inert gas atmosphere of more than 99% purity,
the graphite material is a powder, strip, flake, granule graphite material or a combination thereof and the granule graphite material is made by a granulation process and has a large granule size, and
the graphite material is acid washed with sulfuric acid or hydrofluoric acid and then heat treated at high temperature to remove impurities of the graphite material.

14. The manufacturing method of a carbonaceous heat sink as claimed in claim 13, wherein
the predetermined temperature is at least 2300° C. so as to allow the mixture to be graphitized,
the step of heat treating is performed under a vacuum or an inert gas atmosphere of more than 99% purity,
the graphite material is a powder, strip, flake, granule graphite material or a combination thereof and the granule graphite material is made by a granulation process and has a large granule size, and
the graphite material is acid washed with sulfuric acid or hydrofluoric acid and then heat treated at high temperature to remove impurities of the graphite material.

15. The manufacturing method of a carbonaceous heat sink as claimed in claim 6, wherein
at least one of a metal additive, a ceramic additive and a release agent is mixed into the mixture in the step of mixing, and
the molding step is implemented with a cold pressure forming, a hot pressure forming or an injection molding.

16. The manufacturing method of a carbonaceous heat sink as claimed in claim 15, wherein
the predetermined temperature is at least 600° C. so as to allow the mixture to be carbonized,
the step of heat treating is performed under a vacuum or an inert gas atmosphere of more than 99% purity,
the graphite material is a powder, strip, flake, granule graphite material or a combination thereof and the granule graphite material is made by a granulation process and has a large granule size, and
the graphite material is acid washed with sulfuric acid or hydrofluoric acid and then heat treated at high temperature to remove impurities of the graphite material.

17. The manufacturing method of a carbonaceous heat sink as claimed in claim 16, wherein
the predetermined temperature is at least 2300° C. so as to allow the mixture to be graphitized,
the step of heat treating is performed under a vacuum or an inert gas atmosphere of more than 99% purity,
the graphite material is a powder, strip, flake, granule graphite material or a combination thereof and the granule graphite material is made by a granulation process and has a large granule size, and
the graphite material is acid washed with sulfuric acid or hydrofluoric acid and then heat treated at high temperature to remove impurities of the graphite material.
